(19) United States
(12) Patent Application Publication
(10) Pub. No.: US 2025/0233683 A1
(43) Pub. Date: Jul. 17, 2025

(54) COMMUNICATION CONTROL APPARATUS AND COMMUNICATION CONTROL METHOD

(71) Applicant: NIPPON TELEGRAPH AND TELEPHONE CORPORATION, Tokyo (JP)

(72) Inventors: Shin KANEKO, Musashino-shi (JP); Takuya KANAI, Musashino-shi (JP); Naotaka SHIBATA, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/854,442

(22) PCT Filed: Apr. 12, 2022
(86) PCT No.: PCT/JP2022/017583

§ 371 Date: Oct. 4, 2024

(51) Int. Cl. H04J 14/02; H04B 10/27

(52) U.S. Cl. CPC H04J 14/0227; H04B 10/27

(57) ABSTRACT

A communication control device that controls setting of an optical path between a first communication device and a second communication device includes: a detection unit that detects a main signal on which an uplink control signal transmitted from the first communication device is superimposed and detects a transmission timing of the uplink control signal; a determination unit that determines a transmission timing of a downlink control signal so as not to overlap with the transmission timing of the uplink control signal on the basis of the transmission timing of the uplink control signal detected by the detection unit and a predetermined control signal transmission rule; and a transmission unit that transmits the downlink control signal to the second communication device at the transmission timing of the downlink control signal determined by the determination unit.

### TECHNICAL FIELD

The present invention relates to a communication control apparatus and a communication control method.

### BACKGROUND ART

In order to implement a new network infrastructure that enables high speed and large capacity, drastic reduction in delay, and reduction in power consumption, which cannot be achieved in current networks, research on an all photonics network (APN) based on photonics technology has been underway (see, for example, Non Patent Literature 1). The APN can reduce delay to the utmost by providing an end-to-end and full-mesh optical path connection utilizing a wavelength and can flexibly provide a high-speed and large-capacity functional wavelength dedicated network.

In the APN, in a case where a new subscriber device is connected to a network, a subscriber device management control unit in an APN controller recognizes that the subscriber device is connected and dispenses a wavelength from unused wavelengths to instruct the subscriber device to set the wavelength. At the same time, an optical allocation control unit in the APN controller selects an optimum optical path according to a communication partner of the subscriber device and sets the optical path by optical allocation means in a photonic gateway (Ph-GW). In this manner, automatic opening of an end-to-end optical path is implemented.

As described above, in the optical communication system in related art, the optical allocation control unit sets an inter-port connection by the optical allocation means so that the subscriber device at the time of initial connection can communicate with the subscriber device management control unit. As soon as registration, authentication, wavelength setting, and the like, of the subscriber device are completed, the optical allocation control unit changes the inter-port connection by the optical allocation means and opens an optical path directly connected to the subscriber device that becomes the communication partner. However, in the configuration of the optical communication system in related art, after the optical path is once opened, the communication path between the subscriber device and the subscriber device management control unit is cut off. Thus, there is no control channel for transmitting a control signal from the control unit to the subscriber device as it is.

Thus, a method is considered in which optical multiplexing/demultiplexing means is provided on an optical fiber transmission path to multiplex and demultiplex an optical signal that carries a main signal and an optical signal that carries a control signal, and a management control port for communication with the subscriber device after the optical path is opened is provided in the subscriber device management control unit. Then, by connecting the management control port for communication with the subscriber device after the optical path is opened and the optical multiplexing/demultiplexing means, the optical communication system can transmit an uplink control signal from the subscriber device to the subscriber device management control unit and a downlink control signal from the subscriber device management control unit to the subscriber device even after the optical path is opened.

### CITATION LIST

### Non Patent Literature

Non Patent Literature 1: Takuya Kanai, Kazuaki Honda, Yasunari Tanaka, Shin Kaneko, Kazuki Hara, Junichi Kani, Tomoaki Yoshida, “Photonic Gateway for All-Photonics Network”, IEICE general conference B-8-20, March 2021

### SUMMARY OF INVENTION

### Technical Problem

However, in the optical communication system in related art as described above, there is a case where an uplink control signal (undesired signal) remaining at the same wavelength as the main signal transmitted from one subscriber device to the other subscriber device that is the communication partner and a downlink control signal (desired signal) carried from the control device to the other subscriber device at a different wavelength from the main signal may reach the other subscriber device at the same timing. In this case, interference occurs during detection, and thus, there is a problem that the other subscriber device cannot correctly receive the downlink control signal.

The present invention has been made in view of the above technical background, and an object of the present invention is to provide a technique that enables a subscriber device to receive a downlink control signal without interfering with an uplink control signal remaining at the same wavelength as the main signal transmitted from a subscriber device that is a communication partner.

### Solution to Problem

One aspect of the present invention is a communication control device that controls setting of an optical path between a first communication device and a second communication device, the communication control device including: a detection unit that detects a transmission timing of an uplink control signal by detecting a main signal on which the uplink control signal transmitted from the first communication device is superimposed; a determination unit that determines a transmission timing of a downlink control signal so as not to overlap with the transmission timing of the uplink control signal on the basis of the transmission timing of the uplink control signal detected by the detection unit and a predetermined control signal transmission rule; and a transmission unit that transmits the downlink control signal to the second communication device at the transmission timing of the downlink control signal determined by the determination unit.

Further, one aspect of the present invention is a communication control method for controlling setting of an optical path between a first communication device and a second communication device, the communication control method including: a detection step of detecting a transmission timing of an uplink control signal by detecting a main signal on which the uplink control signal transmitted from the first communication device is superimposed; a determination step of determining a transmission timing of a downlink control signal so as not to overlap with the transmission timing of the uplink control signal on the basis of the transmission timing of the uplink control signal detected in the detection step and a predetermined control rule; and a transmission step of transmitting the downlink control signal to the second communication device at the transmission timing of the downlink control signal determined in the determination step.

### Advantageous Effects of Invention

The present invention enables a subscriber device to receive a downlink control signal without interfering with an uplink control signal remaining at the same wavelength as the main signal transmitted from a subscriber device that is a communication partner.

### BRIEF DESCRIPTION OF DRAWINGS

FIG. 1 is a view for explaining an optical path opening method in an optical communication system 1 in related art.

FIG. 2 is an overall configuration diagram of an optical communication system 1′ in related art.

FIG. 3 is a view for explaining an optical path opening method in an optical communication system 1a according to a first embodiment of the present invention.

FIG. 4 is a view for explaining transmission timing control of a downlink control signal by a subscriber device management control unit 21 according to the first embodiment of the present invention.

FIG. 5 is a view illustrating an example of transmission timings of control signals by the optical communication system 1a according to the first embodiment of the present invention.

FIG. 6 is a view illustrating an example of transmission timings of control signals by the optical communication system 1a according to the first embodiment of the present invention.

FIG. 7 is a flowchart indicating operation of a downlink control signal superimposition unit 210 according to the first embodiment of the present invention.

FIG. 8 is an overall configuration diagram of an optical communication system 1b according to a second embodiment of the present invention.

FIG. 9 is an overall configuration diagram of an optical communication system 1c according to a third embodiment of the present invention.

### DESCRIPTION OF EMBODIMENTS

Hereinafter, a communication control device and a communication control method according to embodiments will be described with reference to the drawings.

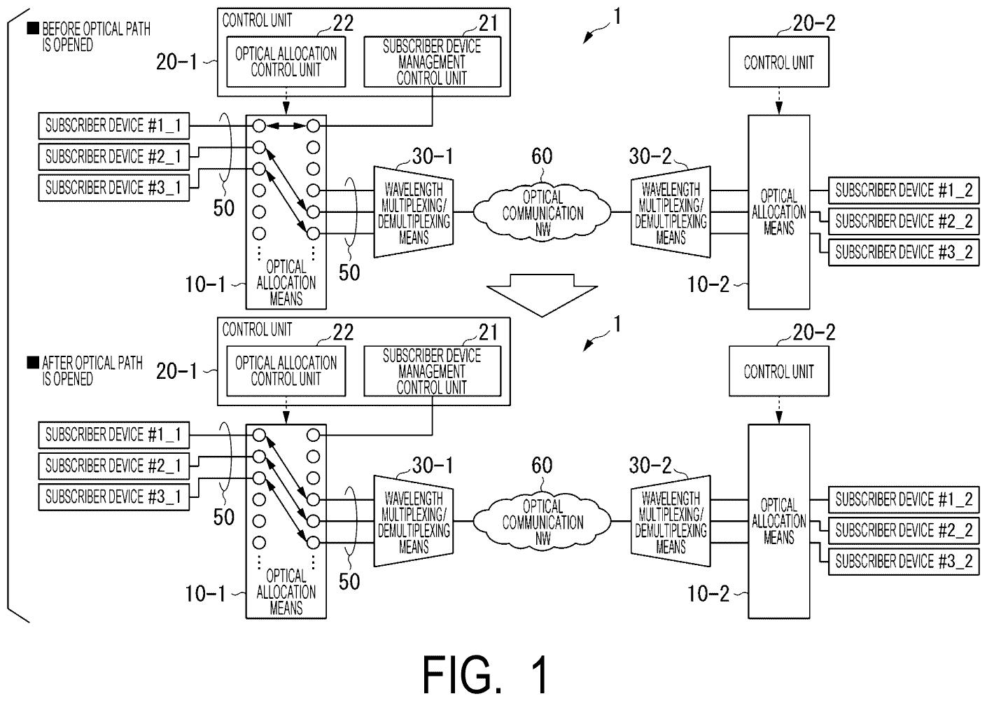

Hereinafter, in order to make the description easy to understand, first, a configuration of an optical communication system 1 which is an example of an optical communication system in related art will be described. FIG. 1 is a view for explaining an optical path opening method in the optical communication system 1 in related art.

As illustrated in FIG. 1, the optical communication system 1 in related art includes a plurality of subscriber devices #k_1 (k=1, 2, . . . ), a plurality of subscriber devices #k_2 (k=1, 2, . . . ), optical allocation means 10-1 and optical allocation means 10-2, a control unit 20-1 and a control unit 20-2, wavelength multiplexing/demultiplexing means 30-1 and wavelength multiplexing/demultiplexing means 30-2, a plurality of optical fiber transmission paths 50, and an optical communication network (NW) 60. The optical allocation means 10-1 and the optical allocation means 10-2 are constituted using, for example, an optical switch, or the like.

Hereinafter, as an example, an optical path opening method in a case where the subscriber device #k_1 is newly connected to a network and communicably connected to the subscriber device #k_2 that becomes a communication partner via the optical fiber transmission path 50, the optical allocation means 10-1, and the like, will be described. Note that on the contrary, an optical path opening method in a case where the subscriber device #k_2 is newly connected to the network and is connected to the subscriber device #k_1 that becomes a communication partner via the optical fiber transmission path 50, the optical allocation means 10-2, and the like, is similar to the configuration described below.

The optical allocation means 10-1 includes a plurality of ports. The optical allocation means 10-1 is connected to the plurality of optical fiber transmission paths 50. The optical allocation means 10-1 outputs an optical signal input from each port to a port for which a connection relationship is set as a connection port for the port. Note that the connection relationship among the plurality of ports can be arbitrarily changed and set.

The subscriber device #k_1 is connected to the optical allocation means 10-1 via the optical fiber transmission path 50. As illustrated in an upper part of FIG. 1, at the time of initial connection of the subscriber device #k_1 to the network, in order to enable communication between the subscriber device #k_1 and a subscriber device management control unit 21, an optical allocation control unit 22 changes setting of an inter-port connection by the optical allocation means 10-1.

At the time of initial connection of the subscriber device #k_1 to the network, management control information necessary for registration and authentication of the subscriber device #k_1 to the network is exchanged between the subscriber device #k_1 and the subscriber device management control unit 21. In addition, at the time of initial connection of the subscriber device #k_1 to the network, the management control information for giving an instruction of a light emission wavelength to be used by the subscriber device #k_1 is transmitted from the subscriber device management control unit 21 to the subscriber device #k_1. As a channel for transmitting and receiving such management control information, for example, an auxiliary management and control channel (AMCC), or the like, can be used.

Next, as illustrated in a lower part of FIG. 1, as soon as the registration, authentication, wavelength setting, and the like, of the subscriber device #k_1 in the network are completed, the optical allocation control unit 22 changes the setting of the inter-port connection by the optical allocation means 10-1 again in order to transfer the optical signal transmitted from the subscriber device #k_1 to the subscriber device #k_2 that becomes the communication partner. As a result, the optical communication system 1 can open an optical path that directly connects the subscriber device #k_1 and the subscriber device #k_2.

However, in such a configuration of the optical communication system 1 in related art, a communication path between the subscriber device #k_1 and the subscriber device management control unit 21 is cut off after the optical path is once opened, and thus, as illustrated in the lower part of FIG. 1, there is no control channel for transmitting a downlink control signal to be transmitted from the subscriber device management control unit 21 to the subscriber device #k_1 or transmitting an uplink control signal to be transmitted from the subscriber device #k_1 to the subscriber device management control unit 21 as it is. In this case, the subscriber device management control unit 21 cannot monitor a state of the optical path and a state of the subscriber device #k_1 or perform optical path switching control.

Thus, a method is considered in which optical multiplexing/demultiplexing means 70 is provided on the optical fiber transmission path 50 to multiplex and demultiplex an optical signal that carries the main signal and an optical signal that carries a control signal, and a management control port for communication with the subscriber device #k_1 after the optical path is opened is provided in the subscriber device management control unit 21. Then, by connecting the management control port for communication with the subscriber device #k_1 after the optical path is opened, and the optical multiplexing/demultiplexing means 70, the optical communication system 1 can transmit an uplink control signal from the subscriber device #k_1 to the subscriber device management control unit 21 and a downlink control signal from the subscriber device management control unit 21 to the subscriber device #k_1 not only before the optical path is opened but also after the optical path is open.

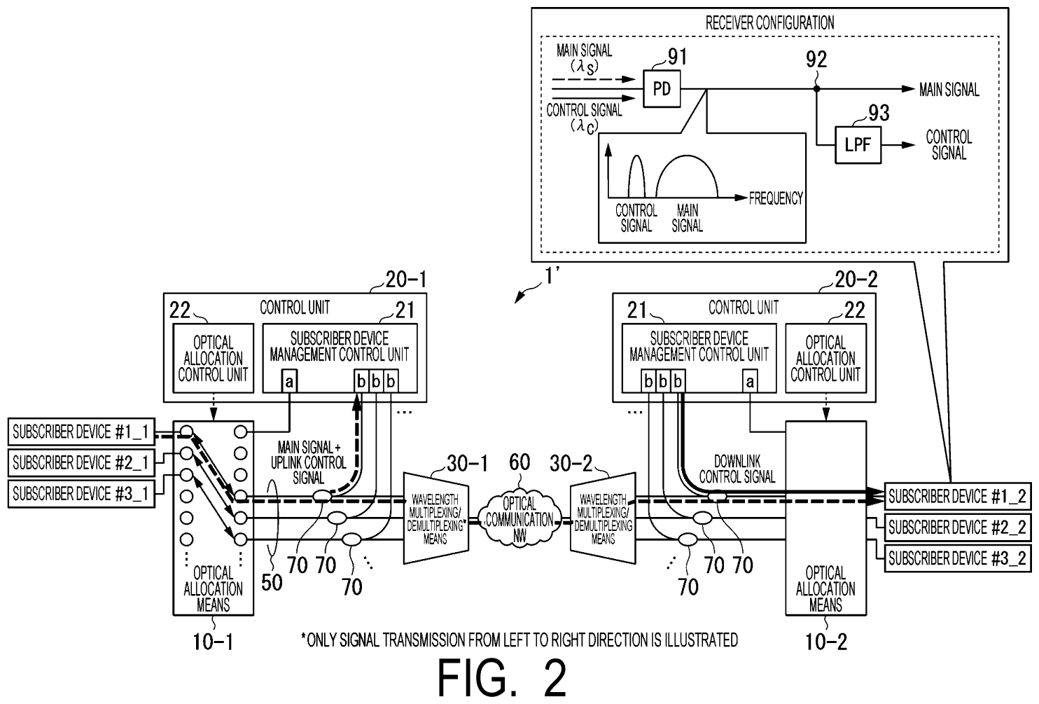

Hereinafter, an overall configuration of an optical communication system 1′ which is an example of an optical communication system in related art will be described. FIG. 2 is an overall configuration diagram of the optical communication system 1′ in related art. As illustrated in FIG. 2, the optical communication system 1′ in related art includes a plurality of subscriber devices #k_1 (k=1, 2, . . . ), a plurality of subscriber devices #k_2 (k=1, 2, . . . ), optical allocation means 10-1 and optical allocation means 10-2, a control unit 20-1 and a control unit 20-2, wavelength multiplexing/demultiplexing means 30-1 and wavelength multiplexing/demultiplexing means 30-2, a plurality of optical fiber transmission paths 50, an optical communication network (NW) 60, and a plurality of optical multiplexing/demultiplexing means 70.

Note that, in the following description, among the components included in the optical communication system 1′ in related art illustrated in FIG. 2, components having configurations similar to those included in the optical communication system 1 in related art illustrated in FIG. 1 are denoted by the same reference numerals, and description thereof is omitted.

As illustrated in FIG. 2, the optical multiplexing/demultiplexing means 70 is provided on each of the plurality of optical fiber transmission paths 50. The optical multiplexing/demultiplexing means 70 is constituted using, for example, an optical multiplexer/demultiplexer, or the like. The subscriber device management control unit 21 is provided with a management control port a which is a management control port for communication with the subscriber device #k_1 before the optical path is opened and a management control port b which is a management control port for communication with the subscriber device #k_1 after the optical path is opened. As a result of the optical multiplexing/demultiplexing means 70 being connected to the management control port b, the optical communication system 1′ in related art can mutually transmit an uplink control signal from the subscriber device #k_1 to the subscriber device management control unit 21 and a downlink control signal from the subscriber device management control unit 21 to the subscriber device #k_1 even after the optical path is opened.

The optical communication system 1′ in related art illustrated in FIG. 2 performs control such that a wavelength of the optical signal that carries the downlink control signal and a wavelength of the optical signal that carries the main signal are different from each other. As a result, the optical communication system 1′ in related art can avoid interference between the main signal and the downlink control signal at the time of reception even in a case where a frequency band of the downlink control signal and a frequency band of the main signal overlap with each other. Specifically, in the optical communication system 1′ in related art, the subscriber device #k_1 separates the downlink control signal and the main signal having wavelengths different from each other and detects and demodulates each of the downlink control signal and the main signal. Accordingly, the subscriber device #k_1 can receive both the downlink control signal and the main signal.

The subscriber device management control unit 21 transmits downlink control signals addressed to the same subscriber device #k_1 from different management control ports before the optical path is opened and after the optical path is opened. Specifically, for example, as illustrated in FIG. 1, the subscriber device management control unit 21 transmits a downlink control signal addressed to the subscriber device #k_1 from the management control port a before the optical path is opened and transmits a downlink control signal addressed to the subscriber device #k_1 from the management control port b after the optical path is opened.

As illustrated in FIG. 2, a receiver included in the subscriber device #k_2 includes a photodiode (PD) 91, electric branching means 92, and a low-pass filter (LPF) 93.

Here, in a case where a wavelength of the optical signal that carries the downlink control signal and a wavelength of the optical signal that carries the main signal are different from each other, and a signal band of the downlink control signal does not overlap with a signal band of the main signal, the subscriber device #k_2 directly detects the wavelength of the optical signal that carries the main signal and the wavelength of the optical signal that carries the control signal collectively by using the photodiode (PD) 91 as illustrated in FIG. 2. The subscriber device #k_2 branches the detected signal component by the electric branching means 92 and then demodulates each signal. With such a configuration, the subscriber device #k_2 can receive both the main signal and the control signal with a simple receiver configuration.

However, in the optical communication system 1′ in related art as described above, the uplink control signal (undesired signal) remaining at the same wavelength as the main signal transmitted from the subscriber device #k_1 and the downlink control signal (desired signal) carried at a different wavelength from the main signal from the subscriber device management control unit 21 of the control unit 20-2 may reach the subscriber device #k_2 at the same timing. In this case, interference occurs at the time of detection, and thus, there is a problem that the subscriber device #k_2 cannot receive the downlink control signal in some cases. An optical communication system according to embodiments of the present invention that can solve such a problem will be described below.

### First Embodiment

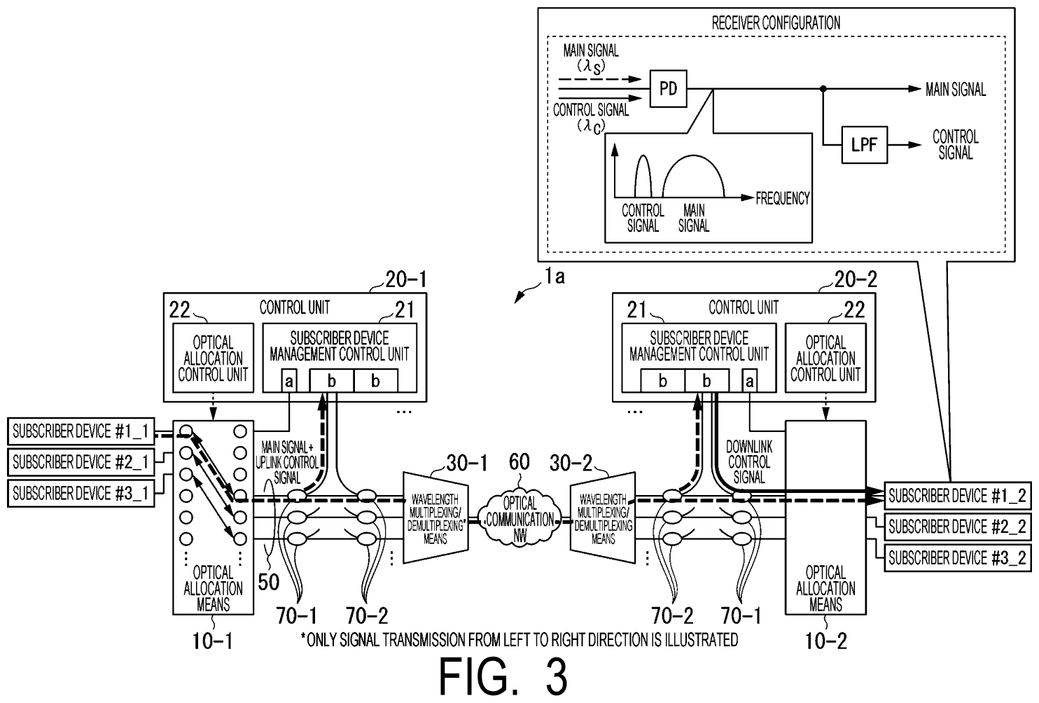

Hereinafter, operation of an optical communication system 1a according to a first embodiment will be described. FIG. 3 is a view for explaining an optical path opening method in the optical communication system 1a according to the first embodiment of the present invention.

As illustrated in FIG. 3, the optical communication system 1a according to the first embodiment includes a plurality of subscriber devices #k_1 (k=1, 2, . . . ), a plurality of subscriber devices #k_2 (k=1, 2, . . . ), optical allocation means 10-1 and optical allocation means 10-2, a control unit 20-1 and a control unit 20-2, wavelength multiplexing/demultiplexing means 30-1 and wavelength multiplexing/demultiplexing means 30-2, a plurality of optical fiber transmission paths 50, an optical communication network (NW) 60, a plurality of first optical multiplexing/demultiplexing means 70-1, and a plurality of second optical multiplexing/demultiplexing means 70-2.

Note that, in the following description, among the components included in the optical communication system 1a according to the first embodiment illustrated in FIG. 3, the components included in the optical communication system 1 in related art illustrated in FIG. 1 and the components included in the optical communication system 1′ in related art illustrated in FIG. 2 are denoted by the same reference numerals, and description thereof is omitted.

A wavelength of the downlink control signal transmitted by the management control port a for communication with the subscriber device #k_2 before the optical path is opened is determined to be λ_{C} in advance. Note that λ_{C} is not necessarily a wavelength different from the wavelength that can be allocated to the main signal after the optical path is opened. For example, in a case where main signal light is turned off when the subscriber device #k_2 is communicating with the management control port a, kc may be set to the same wavelength as the wavelength that can be allocated to the main signal after the optical path is opened. In addition, 4 may be the same wavelength as or a different wavelength from the wavelength allocated to the downlink control signal transmitted by the management control port b for communication with the subscriber device #k_2 after the optical path is opened. However, the wavelength allocated to the downlink control signal transmitted by the management control port b for communication with the subscriber device #k_2 after the optical path is opened needs to be a wavelength different from the wavelength allocated to the main signal after the optical path is opened.

For example, a wavelength-fixed transmitter whose light emission wavelength is kc is used as a transmitter (not illustrated) provided in the subscriber device management control unit 21 that transmits the downlink control signal from the management control port a. Alternatively, for example, a wavelength-tunable transmitter is used as a transmitter (not illustrated) provided in the subscriber device management control unit 21 that transmits the downlink control signal from the management control port a. In a case where the wavelength-tunable transmitter is used, the subscriber device management control unit 21 sets a light emission wavelength of the wavelength-tunable transmitter that transmits the downlink control signal from the management control port a at kc. Note that the light emission wavelength of the wavelength-tunable transmitter that transmits the downlink control signal from the management control port b may be set at the allocated wavelength (kc if kc is similarly allocated).

Note that, in the optical communication system 1a, the wavelength of the downlink control signal does not need to be set at a different wavelength for each subscriber device #k_2 (k=1, 2, . . . ). In other words, the wavelengths of the downlink control signals transmitted from the management control port a for communication with the subscriber device #k_2 before the optical path is opened and the management control port b for communication with the subscriber device #k_2 after the optical path is opened may be fixed at kc in the case of all the subscriber devices #k_2.

In the optical communication system 1a according to the first embodiment, the wavelength λ_{C} of the optical signal of the control signal is set such that a beat component generated when a wavelength λ_{S} of the optical signal that carries the main signal and a wavelength λ_{C} of the optical signal that carries the control signal are collectively detected does not overlap with a control signal component and a main signal component.

In a case where the subscriber device #k_1 transmits the uplink control signal for the control unit 20-1 while the uplink control signal is superimposed on a frequency at which the signal band does not overlap with that of the main signal, it is necessary to prevent interference between the uplink control signal remaining at the same wavelength as the main signal and the downlink control signal carried from the control unit 20-2 at a wavelength different from the main signal at the time of detection by a receiver (not illustrated) included in the subscriber device #k_2. The optical communication system according to the first embodiment determines a transmission timing of the downlink control signal such that the uplink control signal remaining after detection in the subscriber device #k_2 and the downlink control signal for the subscriber device #k_2 are subjected to time division multiplexing (TDM) and transmitted.

As illustrated in FIG. 3, in the optical communication system 1a according to the first embodiment, the first optical multiplexing/demultiplexing means 70-1 and the second optical multiplexing/demultiplexing means 70-2 are provided on each of the plurality of optical fiber transmission paths 50. The first optical multiplexing/demultiplexing means 70-1 and the second optical multiplexing/demultiplexing means 70-2 are constituted using, for example, an optical multiplexer/demultiplexer, or the like.

The subscriber device #k_1 superimposes the uplink control signal for the control unit 20-1 on a frequency at which the signal band does not overlap with that of the main signal and transmits the signal. In addition, the subscriber device management control unit 21 of the control unit 20-2 outputs the downlink control signal for the subscriber device #k_2 at a wavelength λ_{C} different from the wavelength of the optical signal that carries the main signal. Here, the signal band of the control signal is set so as not to overlap with the signal band of the main signal.

As illustrated in FIG. 3, the subscriber device #k_2 directly detects the wavelength of the optical signal that carries the main signal and the wavelength of the optical signal that carries the control signal collectively using the photodiode (PD) 91. The subscriber device #k_2 branches the detected signal component by the electric branching means 92 and then demodulates each signal. With such a configuration, the subscriber device #k_2 can receive both the main signal and the control signal with a simple receiver configuration.

Note that although FIG. 3 illustrates a case where direct detection is performed using the photodiode (PD) 91 that is photoelectric conversion means, an optical communication system using coherent reception can also have a configuration similar to the above receiver configuration.

After the optical path between the subscriber device #k_1 and the subscriber device #k_2 is opened, the first optical multiplexing/demultiplexing means 70-1 (the first optical multiplexing/demultiplexing means 70-1 on the left side in FIG. 3) branches the optical signal that carries the uplink control signal from the subscriber device #k_1 to the control unit 20-1 and inputs one optical signal to the subscriber device management control unit 21 of the control unit 20-1.

In addition, the first optical multiplexing/demultiplexing means 70-1 (the first optical multiplexing/demultiplexing means 70-1 on the right side in FIG. 3) multiplexes the optical signal that carries the downlink control signal from the subscriber device management control unit 21 of the control unit 20-2 to the subscriber device #k_2 and the optical signal that carries the main signal transmitted from the subscriber device #k_1. Accordingly, the subscriber device #k_2 can acquire the downlink control signal.

The second optical multiplexing/demultiplexing means 70-2 (the second optical multiplexing/demultiplexing means 70-2 on the right side in FIG. 3) branches the optical signal on which the uplink control signal remaining at the same wavelength as the main signal transmitted from the subscriber device #k_1 and the main signal are superimposed, and inputs one optical signal to the subscriber device management control unit 21 of the control unit 20-2.

Note that, in the configuration of the optical communication system 1a according to the first embodiment illustrated in FIG. 3, it is assumed that a rightward signal (from the subscriber device #k_1 to the subscriber device #k_2) and a leftward signal (from the subscriber device #k_2 to the subscriber device #k_1) flow through the same optical fiber core wire, but the present invention is not limited to such a configuration. For example, there may be a section in which the rightward signal and the leftward signal flow through different optical fiber core wires.

Note that, in the configuration of the optical communication system 1a in the first embodiment illustrated in FIG. 3, for example, a configuration is assumed in which wavelength multiplexing means having no wavelength selectivity such as an optical coupler is used as the first optical multiplexing/demultiplexing means 70-1 and the second optical multiplexing/demultiplexing means 70-2 to multiplex the optical signal that carries the downlink control signal and the optical signal that carries the main signal. However, the present invention is not limited to such a configuration, and for example, wavelength multiplexing means having wavelength selectivity such as a wavelength filter may be used as the first optical multiplexing/demultiplexing means 70-1 and the second optical multiplexing/demultiplexing means 70-2.

Note that, in the configuration of the optical communication system 1a according to the first embodiment illustrated in FIG. 3, the first optical multiplexing/demultiplexing means 70-1 and the second optical multiplexing/demultiplexing means 70-2 are arranged between the optical allocation means 10-1 and the wavelength multiplexing/demultiplexing means 30-1 and between the optical allocation means 10-2 and the wavelength multiplexing/demultiplexing means 30-2, respectively, but the present invention is not limited to such a configuration. For example, one or both of the first optical multiplexing/demultiplexing means 70-1 and the second optical multiplexing/demultiplexing means 70-2 may be arranged between the optical allocation means 10-1 and the subscriber device #k_1 and between the optical allocation means 10-2 and the subscriber device #k_2.

Note that optical allocation means different from the optical allocation means 10-1 and the optical allocation means 10-2 may be arranged between the management control port b of the subscriber device management control unit 21 and the first optical multiplexing/demultiplexing means 70-1 and the second optical multiplexing/demultiplexing means 70-2, and output of the management control port b may be allocated to the first optical multiplexing/demultiplexing means 70-1 according to a destination of the downlink control signal. In this case, the number of management control ports b can be reduced.

Note that, in the configuration of the optical communication system 1a in the first embodiment illustrated in FIG. 3, the optical allocation means 10-1 and the optical allocation means 10-2 are constituted using, for example, fiber cross connect (FXC) that outputs light input from each port to another port (a connection relationship is set such that a connection port corresponds to the input port) regardless of a wavelength. For example, micro electro mechanical systems (MEMS), a spatial optical switch using a piezo actuator, or the like, is used as the optical allocation means 10-1 and the optical allocation means 10-2.

### [Transmission Timing Control of Downlink Control Signal]

The optical communication system 1a according to the first embodiment controls a transmission timing of the downlink control signal transmitted by the subscriber device management control unit 21. Hereinafter, a configuration of the downlink control signal superimposition unit 210 included in the subscriber device management control unit 21 will be described.

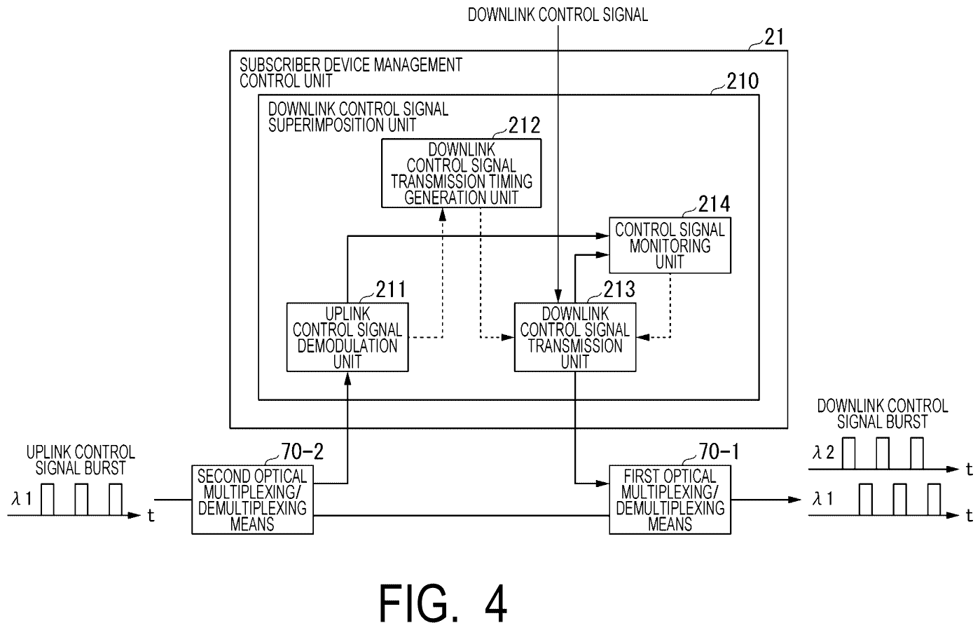

FIG. 4 is a view for explaining transmission timing control of the downlink control signal by the subscriber device management control unit 21 in the first embodiment of the present invention. As illustrated in FIG. 4, the subscriber device management control unit 21 includes the downlink control signal superimposition unit 210. The downlink control signal superimposition unit 210 includes an uplink control signal demodulation unit 211, a downlink control signal transmission timing generation unit 212, a downlink control signal transmission unit 213, and a control signal monitoring unit 214.

The uplink control signal demodulation unit 211 receives input of the optical signal which is branched by the second optical multiplexing/demultiplexing means 70-2, and in which an uplink control signal burst is superimposed on the main signal. The uplink control signal demodulation unit 211 detects the input optical signal and demodulates the uplink control signal burst. The uplink control signal demodulation unit 211 notifies the downlink control signal transmission timing generation unit 212 of a reception timing of the uplink control signal burst in the own uplink control signal demodulation unit 211 on the basis of the demodulation result.

The downlink control signal transmission timing generation unit 212 receives input of the notification indicating the reception timing of the uplink control signal burst from the uplink control signal demodulation unit 211. The downlink control signal transmission timing generation unit 212 determines a transmission timing (trigger) of a downlink control signal burst according to the notified reception timing of the uplink control signal burst and a predetermined control signal transmission rule. The downlink control signal transmission timing generation unit 212 notifies the downlink control signal transmission unit 213 of the determined transmission timing of the downlink control signal burst.

The downlink control signal transmission unit 213 receives input of the notification indicating the transmission timing of the downlink control signal burst from the downlink control signal transmission timing generation unit 212. The downlink control signal transmission unit 213 outputs the optical signal modulated by the downlink control signal burst according to the predetermined control signal transmission rule at the notified transmission timing of the downlink control signal burst. Details of the predetermined control signal transmission rule will be described later. As illustrated in FIG. 4, the output optical signal is multiplexed with the main signal by the first optical multiplexing/demultiplexing means 70-1.

The control signal monitoring unit 214 performs collision detection during downlink control signal burst transmission. In a case where the collision is detected, the control signal monitoring unit 214 instructs the downlink control signal transmission unit 213 to retransmit the downlink control signal burst.

For example, in a case where the subscriber device #k_1 transmits the uplink control signal burst against the control signal transmission rule, the uplink control signal burst and the downlink control signal burst reach the subscriber device #k_2 that is a communication partner at the same time point, and interference may occur. In such a case, by the downlink control signal burst being retransmitted by the control signal monitoring function, the subscriber device #k_2 can reliably receive the downlink control signal transmitted from the subscriber device management control unit 21.

For the transmission timing of the uplink control signal burst, the subscriber device #k_1 may be configured to obtain a transmission permission from the subscriber device management control unit 21 every time the uplink control signal burst is transmitted and transmit the uplink control signal burst or may be configured to voluntarily transmit the uplink control signal burst without requiring a transmission permission each time from the subscriber device management control unit 21.

In a case where the subscriber device #k_1 is configured to voluntarily transmit the uplink control signal burst (the latter configuration), the subscriber device #k_1 transmits the uplink control signal burst according to, for example, an example (No. 1) of the control signal transmission rule or an example (No. 2) of the control signal transmission rule described below. Similarly, the downlink control signal superimposition unit 210 transmits the downlink control signal burst according to, for example, an example (No. 1) of the control signal transmission rule or an example (No. 2) of the control signal transmission rule described below.

### [Example (No. 1) of Control Signal Transmission Rule]

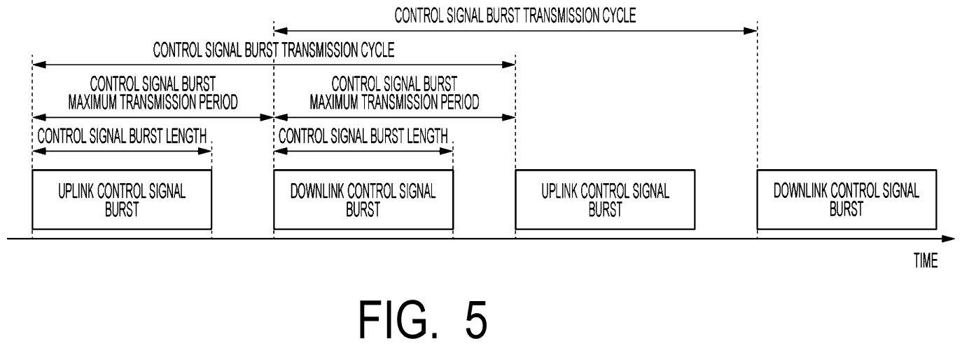

Hereinafter, the example (No. 1) of the control signal transmission rule will be described. FIG. 5 is a view illustrating an example of transmission timings of control signals by the optical communication system 1a according to the first embodiment of the present invention. FIG. 5 indicates time on a horizontal axis.

In the example (No. 1) of the control signal transmission rule, as a time slot in which the uplink control signal can be transmitted, only a control signal burst maximum transmission period is allocated to the subscriber device #k_1 in a control signal burst transmission cycle. In addition, as a time slot in which the downlink control signal can be transmitted, only the control signal burst maximum transmission period is allocated to the downlink control signal superimposition unit 210 of the control unit 20-2 in the control signal burst transmission cycle.

The control signal burst maximum transmission period here is a predetermined period that is an upper limit length allowed per transmission of a control signal. Note that a length of the control signal burst maximum transmission period of the uplink control signal and a length of the control signal burst maximum transmission period of the downlink control signal may be the same or different.

In addition, as illustrated in FIG. 5, the control signal burst transmission cycle is a time interval having a length obtained by adding the control signal burst maximum transmission period of the uplink control signal and the control signal burst maximum transmission period of the downlink control signal. In other words, in a case where the length of the control signal burst maximum transmission period of the uplink control signal is the same as the length of the control signal burst maximum transmission period of the downlink control signal, the control signal burst transmission cycle is a time interval that is twice the length of the control signal burst maximum transmission period.

The downlink control signal superimposition unit 210 starts transmission of the downlink control signal burst to the subscriber device #k_2 after the control signal burst maximum transmission period has elapsed since the uplink control signal burst transmitted from the subscriber device #k_1 has been received.

Note that the downlink control signal superimposition unit 210 of the control unit 20-2 may detect a timing at which the downlink control signal burst can be superimposed on the main signal by observing a reception situation of the uplink control burst transmitted from the subscriber device #k_1 over a certain period and transmit the downlink control signal burst to the subscriber device #k_2 in accordance with the detected timing.

The subscriber device #k_1 transmits the uplink control signal burst in the control signal burst transmission cycle. Here, the subscriber device #k_1 executes transmission of the uplink control signal burst even in a cycle in which control information does not need to be transmitted to the subscriber device management control unit 21 of the control unit 20-1.

This is because the subscriber device management control unit 21 of the control unit 20-2 can voluntarily transmit the downlink control signal to the subscriber device #k_2 by setting the transmission timing of the uplink control signal burst at a predetermined interval. With such a configuration, the downlink control signal superimposition unit 210 can transmit the downlink control signal to the subscriber device #k_2 in a control signal burst transmission cycle regardless of whether or not it is necessary to transmit the control information from the subscriber device #k_1 to the subscriber device management control unit 21 of the control unit 20-1.

Control signal burst lengths of the uplink control signal and the downlink control signal can be set at variable lengths within a range satisfying the condition of the following expression (1).

$$Control signal burst length [ Byte ] \leq control signal burst maximum transmission period [ s ] \times control signal speed [ bps ] \qquad ( 1 )$$

### [Example (No. 2) of Control Signal Transmission Rule]

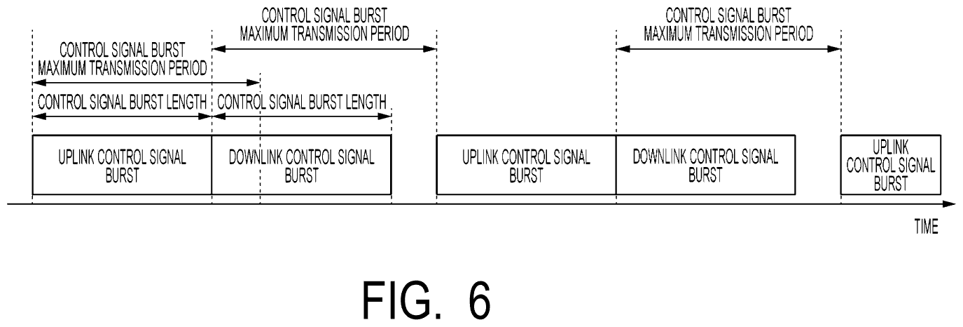

The example (No. 2) of the control signal transmission rule will be described below. FIG. 6 is a view illustrating an example of transmission timings of control signals by the optical communication system 1a according to the first embodiment of the present invention. FIG. 6 indicates time on a horizontal axis.

In the example (No. 2) of the control signal transmission rule, the downlink control signal superimposition unit 210 starts transmission of the downlink control signal burst to the subscriber device #k_2 after a predetermined guard time has elapsed since one reception of the uplink control signal burst transmitted from the subscriber device #k_1 has been completed (that is, since a tail portion of the uplink control signal burst has been received).

The subscriber device #k_1 starts transmission of the next uplink control signal burst after the control signal burst maximum transmission period has elapsed since transmission of the uplink control signal burst has been completed (that is, after the tail portion of the uplink control signal burst has been transmitted). The control signal burst maximum transmission period here is a predetermined period that is an upper limit length allowed per transmission of the uplink control signal.

In addition, similarly to the example (No. 1) of the control signal transmission rule, the subscriber device #k_1 executes transmission of the uplink control signal burst even in a cycle in which control information does not need to be transmitted to the subscriber device management control unit 21 of the control unit 20-1. With such a configuration, regardless of whether or not it is necessary to transmit the control information from the subscriber device #k_1 to the subscriber device management control unit 21 of the control unit 20-1, the downlink control signal superimposition unit 210 can transmit the downlink control signal to the subscriber device #k_2 in the control signal burst transmission cycle that is an interval equal to or less than twice the control signal burst maximum transmission period.

The control signal burst lengths of the uplink control signal and the downlink control signal may be variable lengths within a range that satisfies the condition of the foregoing expression (1).

### [Operation of Downlink Control Signal Superimposition Unit]

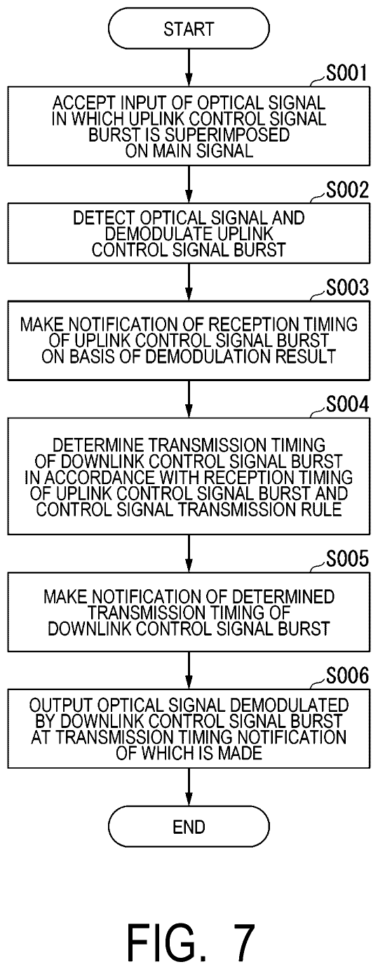

Hereinafter, operation of the downlink control signal superimposition unit 210 will be described. FIG. 7 is a flowchart indicating the operation of the downlink control signal superimposition unit 210 according to the first embodiment of the present invention. The operation of the downlink control signal superimposition unit 210 indicated in the flowchart of FIG. 7 is started when the optical signal which is branched by the second optical multiplexing/demultiplexing means 70-2, and in which the uplink control signal burst is superimposed on the main signal, is input to the uplink control signal demodulation unit 211 of the downlink control signal superimposition unit 210.

First, the uplink control signal demodulation unit 211 receives input of the optical signal in which the uplink control signal burst is superimposed on the main signal (step S001). Next, the uplink control signal demodulation unit 211 detects the input optical signal and demodulates the uplink control signal burst (step S002). Next, the uplink control signal demodulation unit 211 notifies the downlink control signal transmission timing generation unit 212 of a reception timing of the uplink control signal burst in the own uplink control signal demodulation unit 211 on the basis of the demodulation result (step S003).

Next, the downlink control signal transmission timing generation unit 212 determines a transmission timing (trigger) of the downlink control signal burst according to the notified reception timing of the uplink control signal burst and the predetermined control signal transmission rule (step S004). Next, the downlink control signal transmission timing generation unit 212 notifies the downlink control signal transmission unit 213 of the determined transmission timing of the downlink control signal burst (step S005).

Next, the downlink control signal transmission unit 213 outputs the optical signal modulated by the downlink control signal burst according to the predetermined control signal transmission rule at the notified transmission timing of the downlink control signal burst (step S006). As described above, the operation of the downlink control signal superimposition unit 210 indicated in the flowchart of FIG. 7 ends.

### Second Embodiment

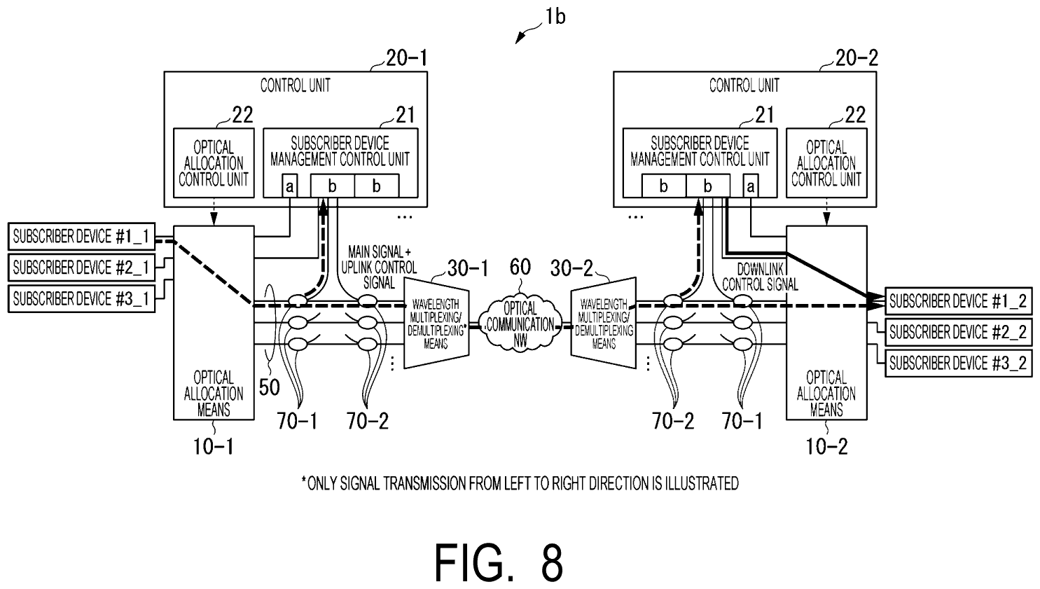

Hereinafter, operation of an optical communication system 1b according to a second embodiment will be described. FIG. 8 is an overall configuration diagram of the optical communication system 1b according to the second embodiment of the present invention.

As illustrated in FIG. 8, the optical communication system 1b according to the second embodiment includes a plurality of subscriber devices #k_1 (k=1, 2, . . . ), a plurality of subscriber devices #k_2 (k=1, 2, . . . ), optical allocation means 10-1 and optical allocation means 10-2, a control unit 20-1 and a control unit 20-2, wavelength multiplexing/demultiplexing means 30-1 and wavelength multiplexing/demultiplexing means 30-2, a plurality of optical fiber transmission paths 50, an optical communication network (NW) 60, a plurality of first optical multiplexing/demultiplexing means 70-1, and a plurality of second optical multiplexing/demultiplexing means 70-2.

Note that, in the following description, among components included in the optical communication system 1b according to the second embodiment illustrated in FIG. 8, components having configurations similar to those included in the optical communication system 1a according to the first embodiment illustrated in FIG. 3 are denoted by the same reference numerals, and description thereof is omitted.

In the optical communication system 1b according to the second embodiment, the optical allocation means 10-1 and the optical allocation means 10-2 can set a transmission path for each wavelength. In this case, as illustrated in FIG. 8, the downlink control signal is input from a port different from the port to which the main signal is input, so that the optical signal that carries the main signal and the optical signal that carries the downlink control signal can be multiplexed. For example, arrayed waveguide gratings (AWG), a wavelength selective switch (WSS), or the like, is used as the optical allocation means 10-1 and the optical allocation means 10-2.

### Third Embodiment

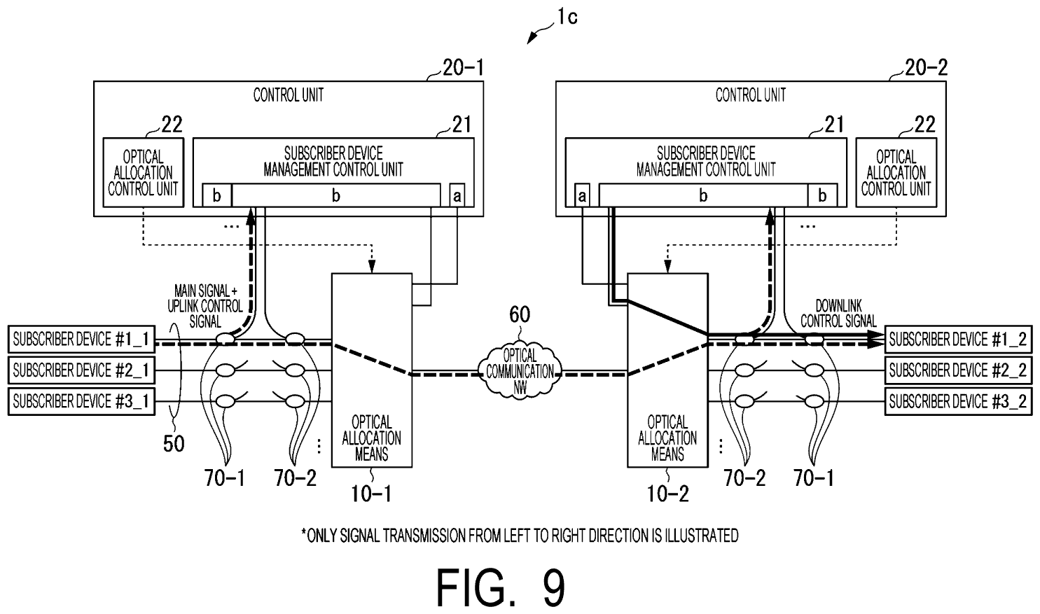

Hereinafter, operation of an optical communication system 1c according to a third embodiment will be described. FIG. 9 is an overall configuration diagram of the optical communication system 1c according to the third embodiment of the present invention.

As illustrated in FIG. 9, the optical communication system 1c according to the third embodiment includes a plurality of subscriber devices #k_1 (k=1, 2, . . . ), a plurality of subscriber devices #k_2 (k=1, 2, . . . ), optical allocation means 10-1 and optical allocation means 10-2, a control unit 20-1 and a control unit 20-2, a plurality of optical fiber transmission paths 50, an optical communication network (NW) 60, a plurality of first optical multiplexing/demultiplexing means 70-1, and a plurality of second optical multiplexing/demultiplexing means 70-2.

Note that, in the following description, among components included in the optical communication system 1c according to the second embodiment illustrated in FIG. 9, components having configurations similar to those included in the optical communication system 1a according to the first embodiment illustrated in FIG. 3 are denoted by the same reference numerals, and description thereof is omitted.

In the optical communication system 1b according to the second embodiment illustrated in FIG. 8 described above, the first optical multiplexing/demultiplexing means 70-1 and the second optical multiplexing/demultiplexing means 70-2 are arranged between the optical allocation means 10-1 and the wavelength multiplexing/demultiplexing means 30-1 and between the optical allocation means 10-2 and the wavelength multiplexing/demultiplexing means 30-2. On the other hand, one or both of the first optical multiplexing/demultiplexing means 70-1 and the second optical multiplexing/demultiplexing means 70-2 may be arranged between the optical allocation means 10-1 and the subscriber device #k_1 and between the optical allocation means 10-2 and the subscriber device #k_2. FIG. 9 illustrates a configuration in which both the first optical multiplexing/demultiplexing means 70-1 and the second optical multiplexing/demultiplexing means 70-2 are arranged between the optical allocation means 10-1 and the subscriber device #k_1 and between the optical allocation means 10-2 and the subscriber device #k_2.

The optical communication system 1b according to the second embodiment illustrated in FIG. 8 described above has a configuration in which each optical path is wavelength-multiplexed by the optical allocation means 10-1 and the optical allocation means 10-2 including, for example, AWG or WSS. However, in a case where the first optical multiplexing/demultiplexing means 70-1 and the second optical multiplexing/demultiplexing means 70-2 are arranged between the optical allocation means 10-1 and the subscriber device #k_1 and between the optical allocation means 10-2 and the subscriber device #k_2, the optical allocation means 10-1 and the optical allocation means 10-2 can perform wavelength multiplexing on each optical path, and thus, for example, as illustrated in FIG. 9, the wavelength multiplexing/demultiplexing means 30-1 and the wavelength multiplexing/demultiplexing means 30-2 can be omitted.

Note that, in the configuration of the optical communication system 1c according to the third embodiment illustrated in FIG. 9, a multicast switch (MCS) can also be used as the optical allocation means 10-1 and the optical allocation means 10-2. In this case, wavelength filters may be provided between the optical allocation means 10-1 and the second optical multiplexing/demultiplexing means 70-2 (the second optical multiplexing/demultiplexing means 70-2 on the left side of FIG. 9) and between the optical allocation means 10-1 and the second optical multiplexing/demultiplexing means 70-2 (the second optical multiplexing/demultiplexing means 70-2 on the right side of FIG. 9).

As described above, the optical communication system according to each of the above-described embodiments includes the configuration for setting the transmission timing of the downlink control signal such that the uplink control signal remaining after detection in the subscriber device #k_2 and the downlink control signal for the subscriber device #k_2 are subjected to time division multiplexing (TDM) and transmitted.

Specifically, in the optical communication system in each of the above-described embodiments, the first optical multiplexing/demultiplexing means 70-1 and the second optical multiplexing/demultiplexing means 70-2 are provided on each of the plurality of optical fiber transmission paths 50. The subscriber device #k_1 superimposes the uplink control signal for the control unit 20-1 on a frequency at which the signal band does not overlap with that of the main signal and transmits the signal. In addition, the subscriber device management control unit 21 of the control unit 20-2 outputs the downlink control signal for the subscriber device #k_2 at a wavelength λ_{C} different from the wavelength of the optical signal that carries the main signal. Here, the signal band of the control signal is set so as not to overlap with the signal band of the main signal. Then, the downlink control signal superimposition unit 210 of the control unit 20-2 receives the uplink control signal, grasps a reception timing of the uplink control signal burst, generates the downlink control signal burst according to the reception timing and the predetermined control signal transmission rule and transmits the downlink control signal burst to the subscriber device #k_1.

With such a configuration, according to the optical communication system in each of the above-described embodiments, the subscriber device #k_2 can receive the downlink control signal transmitted from the subscriber device management control unit 21 without interfering with the uplink control signal transmitted from the subscriber device #k_1, which is the communication partner, to the subscriber device management control unit 21 of the control unit 20-1 with a simple receiver configuration. As a result, according to the optical communication system in each of the above-described embodiments, after the optical path between the subscriber device #k_1 and the subscriber device #k_2 is opened, a control signal can be exchanged between the subscriber device and the management control port b of the subscriber device management control unit 21, and the subscriber device management control unit 21 can monitor states of the optical path and the subscriber device and perform optical path switching control.

In addition, with such a configuration, according to the optical communication system in each of the above-described embodiments, after the optical path is once opened, the subscriber device #k_1 can voluntarily transmit the uplink control signal without requiring a configuration for obtaining a transmission permission from the subscriber device management control unit 21 every time the uplink control signal burst is transmitted.

According to the above-described embodiment, a communication control device(apparatus) that controls setting of an optical path between a first communication device and a second communication device includes a detection unit, a determination unit, and a transmission unit. For example, the first communication device is the subscriber device #k_1 in the embodiments, the second communication device is the subscriber device #k_2 in the embodiments, the communication control device is the control unit 20-2 in the embodiments, the detection unit is the uplink control signal demodulation unit 211 in the embodiments, the determination unit is the downlink control signal transmission timing generation unit 212 in the embodiments, and the transmission unit is the downlink control signal transmission unit 213 in the embodiments.

The detection unit detects the main signal on which the uplink control signal transmitted from the first communication device is superimposed and detects the transmission timing of the uplink control signal. The determination unit determines the transmission timing of the downlink control signal so as not to overlap with the transmission timing of the uplink control signal on the basis of the transmission timing of the uplink control signal detected by the detection unit and the predetermined control signal transmission rule. The transmission unit transmits the downlink control signal to the second communication device at the transmission timing of the downlink control signal determined by the determination unit.

Note that, in the communication control device(apparatus) described above, the predetermined control signal transmission rule may be a rule in which the timing after the control signal maximum transmission period has elapsed since the timing at which the uplink control signal has been detected by the detection unit is set as the transmission start timing of the downlink control signal, and the control signal maximum transmission period may be set as a length of the upper limit allowed per transmission of the uplink control signal. For example, the control signal maximum transmission period is the control signal burst maximum transmission period in the embodiments.

Note that, in the above-described communication control device(apparatus), the uplink control signal may be transmitted from the first communication device in a cycle having a length twice the length of the control signal maximum transmission period.

In the communication control device(apparatus) described above, the predetermined control signal transmission rule may be a rule in which a timing after a predetermined period has elapsed since a timing at which the detection unit has no longer detected the uplink control signal is set as the transmission start timing of the downlink control signal.

Note that, in the above-described communication control device(apparatus), the uplink control signal may be transmitted from the first communication device after the control signal maximum transmission period has elapsed since the timing at which the previous transmission of the uplink control signal has been completed in the first communication device, and the control signal maximum transmission period may be a period that is a length of the upper limit allowed per transmission of the uplink control signal.

Note that the communication control device(apparatus) may further include a retransmission instruction unit. For example, the retransmission instruction unit is the control signal monitoring unit 214 in the embodiments. In a case where a collision between the uplink control signal and the downlink control signal occurring in the second communication device is detected, the retransmission instruction unit instructs the transmission unit to retransmit the downlink control signal.

Note that, in the above-described communication control device(apparatus), the first wavelength that is the wavelength of the optical signal that carries the downlink control signal may be a wavelength set such that a beat component generated when the first wavelength and the second wavelength that is the wavelength of the optical signal that carries the main signal are collectively detected does not overlap with a component of the main signal and a component of the control signal. For example, the first wavelength is the wavelength λ_{C} in the embodiments, and the second wavelength is the wavelength λ_{S} in the embodiments.

Part of the configurations of the optical communication systems 1a to 1c in the above-described embodiments may be implemented by a computer. In that case, a program for implementing this function may be recorded in a computer-readable recording medium, and the program recorded in the recording medium may be read and executed by a computer system to implement this function. The “computer system” herein includes an OS and hardware such as a peripheral device. In addition, the “computer-readable recording medium” refers to a portable medium such as a flexible disk, a magneto-optical disk, a ROM, or a CD-ROM, or a storage device such as a hard disk built in a computer system. Further, the “computer-readable recording medium” may include a medium that dynamically holds the program for a short period of time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, the specific configuration is not limited to the embodiments, and includes design, and the like, within the scope not departing from the gist of the present invention.

### REFERENCE SIGNS LIST

1, 1′, 1a to 1c Optical communication system
10-1 to 10-2 Optical allocation means
20-1 to 20-2 Control unit
21 Subscriber device management control unit
22 Optical allocation control unit
30-1 to 30-2 Wavelength multiplexing/demultiplexing means
50 Optical fiber transmission path
60 Optical communication network (NW)
70-1 First optical multiplexing/demultiplexing means
70-2 Second optical multiplexing/demultiplexing means
91 Photodiode (PD)
92 Electric branching means
93 Low-pass filter (LPF)
210 Control signal superimposition unit
211 Control signal demodulation unit
212 Control signal transmission timing generation unit
213 Control signal transmission unit
214 Control signal monitoring unit

1. A communication control device that controls setting of an optical path between a first communication device and a second communication device, the communication control device comprising:
a detector that detects a transmission timing of an uplink control signal by detecting a main signal on which the uplink control signal transmitted from the first communication device is superimposed;
a determination controller that determines a transmission timing of a downlink control signal so as not to overlap with the transmission timing of the uplink control signal on a basis of the transmission timing of the uplink control signal detected by the detector and a predetermined control signal transmission rule; and
a transmitter that transmits the downlink control signal to the second communication device at the transmission timing of the downlink control signal determined by the determination controller.

2. The communication control device according to claim 1,
wherein the predetermined control signal transmission rule is a rule that sets a timing after a control signal maximum transmission period has elapsed since a timing at which the detector has detected the uplink control signal as a transmission start timing of the downlink control signal, and
the control signal maximum transmission period is a period that is an upper limit length allowed per transmission of the uplink control signal.

3. The communication control device according to claim 2,
wherein the uplink control signal is transmitted from the first communication device in a cycle that is twice a length of the control signal maximum transmission period.

4. The communication control device according to claim 1,
wherein the predetermined control signal transmission rule is a rule that sets a timing after a predetermined period has elapsed since a timing at which the detector has no longer detected the uplink control signal as a transmission start timing of the downlink control signal.

5. The communication control device according to claim 4,
wherein the uplink control signal is transmitted from the first communication device after a control signal maximum transmission period has elapsed since a timing at which previous transmission of the uplink control signal has been completed in the first communication device, and
the control signal maximum transmission period is a period that is an upper limit length allowed per transmission of the uplink control signal.

6. The communication control device according to claim 1, further comprising:
a retransmission instruction controller that instructs the transmitter to retransmit the downlink control signal in a case where a collision between the uplink control signal and the downlink control signal occurring in the second communication device is detected.

7. The communication control device according to claim 1,
wherein a first wavelength that is a wavelength of the optical signal that carries the downlink control signal is set such that a beat component generated when the first wavelength and a second wavelength that is a wavelength of the optical signal that carries the main signal are collectively detected does not overlap with a component of the main signal and a component of the control signal.

8. A communication control method for controlling setting of an optical path between a first communication device and a second communication device, the communication control method comprising:
detecting a transmission timing of an uplink control signal by detecting a main signal on which the uplink control signal transmitted from the first communication device is superimposed;
determining a transmission timing of a downlink control signal so as not to overlap with the transmission timing of the uplink control signal on a basis of the transmission timing of the uplink control signal and a predetermined control rule; and
transmitting the downlink control signal to the second communication device at the transmission timing of the downlink control signal determined.
